(19) United States
(12) Patent Application Publication
(10) Pub. No.: US 2026/0215248 A1
(43) Pub. Date: Jul. 23, 2026

(54) SIGNAL PATH ROUTING IN DIE-TO-DIE BONDED CIRCUITS

(71) Applicant: Tokyo Electron Limited, Tokyo (JP)

(72) Inventors: Mark I. GARDNER, Austin, TX (US); H. Jim FULFORD, Marianna, FL (US)

(73) Assignee: Tokyo Electron Limited, Tokyo (JP)

(21) Appl. No.: 19/454,144

(22) Filed: Jan. 20, 2026

Related U.S. Application Data
(60) Provisional application No. 63/748,792, filed on Jan. 23, 2025.

(51) Int. Cl. H10W 20/41; G06F 30/394; H10W 20/43; H10W 90/00; H10W 90/26; G06F 119/06; H10W 80/00

(52) U.S. Cl. CPC H10W 20/427; G06F 30/394; H10W 20/43; H10W 90/26; H10W 90/792; G06F 2119/06; H10W 80/314

(57) ABSTRACT

A device includes a first die including first integrated circuitry and first conductive wiring layers. The first conductive wiring layers include a power line and a ground line. The device also includes a second die including second integrated circuitry and second conductive wiring layers. The second conductive wiring layers include no power line and no ground line. The first die is aligned with and bonded to the second die. The first conductive wiring layers are electrically connected with the second conductive wiring layers. The second die uses the power line and the ground line of the first die.

### INCORPORATION BY REFERENCE

This present disclosure claims the benefit of U.S. Provisional Application No. 63/748,792, filed on January 23, 2025, which is incorporated herein by reference in its entirety.

### FIELD OF THE INVENTION

This disclosure relates to microelectronic devices including semiconductor devices, transistors, and integrated circuits, and methods of microfabrication including electronic design automation (EDA).

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

In the manufacture of a semiconductor device (especially on the microscopic scale), various fabrication processes are executed such as film-forming depositions, etch mask creation, patterning, material etching and removal, and doping treatments. These processes are performed repeatedly to form desired semiconductor device elements on a substrate. Historically, with microfabrication, transistors have been created in one plane, with wiring/metallization formed above the active device plane, and have thus been characterized as two-dimensional (2D) circuits or 2D fabrication. Scaling efforts have greatly increased the number of transistors per unit area in 2D circuits, yet scaling efforts are running into greater challenges as scaling enters single digit nanometer semiconductor device fabrication nodes. Semiconductor device fabricators have expressed a desire for three-dimensional (3D) semiconductor circuits in which transistors are stacked on top of each other.

### SUMMARY

The present disclosure relates to a device and a method of forming the same.

According to aspect (1) of the disclosure, a device is provided. The device includes a first die including first integrated circuitry and first conductive wiring layers. The first conductive wiring layers include a power line and a ground line. The device also includes a second die including second integrated circuitry and second conductive wiring layers. The second conductive wiring layers include no power line and no ground line. The first die is aligned with and bonded to the second die. The first conductive wiring layers are electrically connected with the second conductive wiring layers. The second die uses the power line and the ground line of the first die.

Aspect (2) includes the method of aspect (1), wherein the power line and the ground line are positioned proximate a bonding interface between the first die and the second die.

Aspect (3) includes the method of aspect (2), wherein the first conductive wiring layers comprise first metal layers and first signal path routing, which are designed using an automated wiring design system that incorporates artificial intelligence-based decision making.

Aspect (4) includes the method of aspect (3), wherein the second conductive wiring layers comprise second metal layers and second signal path routing, which are designed using the automated wiring design system.

Aspect (5) includes the method of aspect (3), wherein the automated wiring design system places wires that result in at least one of a reduction of a power metric, an increase in a performance metric, a reduction of a cost metric, and a reduction in a cost metric, compared to a design without using the automated wiring system.

Aspect (6) includes the method of aspect (1), wherein the first integrated circuitry comprises first transistors, and the first die further comprises first vertical conductive structures that electrically connect the first transistors to at least one of the first wiring layers, the power line or the ground line.

Aspect (7) includes the method of aspect (6), wherein the second integrated circuitry comprises second transistors, and the second die further comprises second vertical conductive structures that electrically connect the second transistors to at least one of the second wiring layers.

Aspect (8) includes the method of aspect (7), further including conductive bonding structures extending from the first die to the second die through a bonding interface therebetween. The second transistors are electrically connected to the power line and the ground line of the first die by the second vertical conductive structures and the conductive bonding structures.

Aspect (9) includes the method of aspect (1), wherein the power line and the ground line are positioned in at least one power and ground plane that is adjacent to a bonding interface between the first die and the second die.

Aspect (10) includes the method of aspect (9), wherein the first die comprises no buried power rail (BPR), between which and the bonding interface, the first integrated circuitry is positioned, and the second die comprises no BPR, between which and the bonding interface, the second integrated circuitry is positioned.

Aspect (11) includes the method of aspect (9), wherein the second integrated circuitry is electrically connected to the at least one power and ground plane of the first die via the second conductive wiring layers and the bonding interface.

Aspect (12) includes the method of aspect (9), further including conductive bonding structures extending from the first die through the bonding interface to the second die. The second integrated circuitry is electrically connected to the at least one power and ground plane of the first die via the second conductive wiring layers and the conductive bonding structures.

Aspect (13) includes the method of aspect (9), wherein the first die further comprises a first substrate, and the second die further comprises a second substrate.

Aspect (14) includes the method of aspect (13), wherein the first die, the first integrated circuitry, the first conductive wiring layers, the bonding interface, the second conductive wiring layers, the second integrated circuitry and the second die are sequentially arranged along a direction perpendicular to the bonding interface.

Aspect (15) includes the method of aspect (9), wherein the first conductive wiring layers further comprise first metal layers, and the second conductive wiring layers comprise second metal layers.

Aspect (16) includes the method of aspect (15), wherein the at least one power and ground plane is positioned between the first metal layers and the second metal layers.

According to aspect (17) of the disclosure, a method of manufacturing a device is provided. The method includes forming a first die comprising first integrated circuitry and first conductive wiring layers and forming a second die comprising second integrated circuitry and second conductive wiring layers. The first conductive wiring layers comprise a power line and a ground line. The second conductive wiring layers comprise no power line and no ground line. The method also includes bonding the first die to the second die such that the first die is aligned with the second die, the first conductive wiring layers are electrically connected with the second conductive wiring layers, and the second die uses the power line and the ground line of the first die.

Aspect (18) includes the method of aspect (17), wherein forming the first die comprises designing a first signal path using an automated wiring design system that incorporates artificial intelligence-based decision making.

Aspect (19) includes the method of aspect (18), wherein forming the second die comprises designing a second signal path using the automated wiring design system.

Aspect (20) includes the method of aspect (19), wherein forming the second die comprises designing a second signal path using the automated wiring design system. The automated wiring design system places wires that result in at least one of a reduction of a power metric, an increase in a performance metric, a reduction of a cost metric, or a reduction in a cost metric, compared to a design without using the automated wiring system.

Note that this summary section does not specify every embodiment and/or incrementally novel aspect of the present disclosure or claimed invention. Instead, this summary only provides a preliminary discussion of different embodiments and corresponding points of novelty. For additional details and/or possible perspectives of the invention and embodiments, the reader is directed to the Detailed Description section and corresponding figures of the present disclosure as further discussed below.

### BRIEF DESCRIPTION OF THE DRAWINGS

Aspects of the present disclosure are best understood from the following detailed description when read with the accompanying figures. Changes and modifications may be made within the scope herein without departing from the spirit and scope thereof. It is noted that, in accordance with the standard practice in the industry, various features are not drawn to scale. In fact, the dimensions of the various features may be increased or reduced for clarity of discussion.

FIG. 1A shows a vertical cross-sectional view of a semiconductor device in accordance with one embodiment of the present disclosure.

FIG. 1B shows a vertical cross-sectional view of a semiconductor device in accordance with another embodiment of the present disclosure.

FIG. 1C shows a vertical cross-sectional view of a semiconductor device in accordance with yet another embodiment of the present disclosure.

FIG. 1D shows a vertical cross-sectional view of a semiconductor device in accordance with yet another embodiment of the present disclosure.

FIG. 2A shows a flow chart of a process for manufacturing a semiconductor device, in accordance with some embodiments of the present disclosure.

FIG. 2B shows a flow chart of a process for manufacturing a semiconductor device, in accordance with some embodiments of the present disclosure.

FIG. 3 shows vertical cross-sectional views of semiconductor devices prior to bonding, in accordance with some embodiments of the present disclosure.

FIG. 4 shows vertical cross-sectional views of semiconductor devices prior to bonding, in accordance with some embodiments of the present disclosure.

FIG. 5 shows vertical cross-sectional views of semiconductor devices prior to bonding, in accordance with some embodiments of the present disclosure.

FIGS. 6A and 6B show vertical cross-sectional views of semiconductor devices at various intermediate steps of manufacturing, in accordance with some embodiments of the present disclosure.

FIGS. 7A and 7B show vertical cross-sectional views of semiconductor devices at various intermediate steps of manufacturing, in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed. Further, spatially relative terms, such as “top,” “bottom,” “beneath,” “below,” “lower,” “above,” “upper” and the like, may be used herein for ease of description to describe one element or feature’s relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

The order of discussion of the different steps as described herein has been presented for clarity’s sake. In general, these steps can be performed in any suitable order. Additionally, although each of the different features, techniques, configurations, etc. herein may be discussed in different places of this disclosure, it is intended that each of the concepts can be executed independently of each other or in combination with each other. Accordingly, the present invention can be embodied and viewed in many different ways.

In the drawings, like reference numerals designate identical or corresponding parts throughout the several views. Additionally, as used herein, the words “a”, “an” and the like generally carry a meaning of “one or more”, unless stated otherwise.

Furthermore, the terms, “approximately”, “approximate”, “about” and similar terms generally refer to ranges that include the identified value within a margin of 20%, 10%, or preferably 5%, and any values therebetween.

When amounts, concentrations, dimensions and other parameters are expressed in the form of a range, an upper limit value, a lower limit value or a specific value, it should be understood that any ranges obtainable by combining any upper limit or specific value with any lower limit or specific value are also specifically disclosed, irrespective of whether the obtained ranges are clearly mentioned in the context. A numerical range represented by “between… and…”, “to”, “from… to…”, “-” and similar terms includes numerical values at both ends, unless specified otherwise.

3D integration, i.e. the vertical stacking of multiple devices, aims to overcome scaling limitations experienced in planar devices by increasing transistor density in volume rather than area. Although device stacking has been successfully demonstrated and implemented by the flash memory industry with the adoption of 3D NAND, application to random logic designs is substantially more difficult. 3D integration for logic chips (CPU (central processing unit), GPU (graphics processing unit), FPGA (field programmable gate array, SoC (System on a chip)) is being pursued.

Conventionally, each individual die is designed for routing of power and ground at the top of each die. And then, conventionally, when combining two dies, each die has a fixed output for connections that cannot be optimized by artificial intelligence (AI) electronic design automation (EDA) for power performance area and cost (PPAC). Each conventional die may contain a stack of 12 or more metal routing layers, which, when combined, creates 24 or more metal layers. Thus when 2 dies are bonded together, they must be connected at the fixed individual die locations that are not optimized for PPAC. This conventional technique adds 2-4 additional masking steps and also is unable to be effectively routed because metal routing is only optimized for a single die system.

Aspects of the present disclosure are related to electronic design automation (EDA). EDA includes the process of converting a logical design of a circuit to a physical design for microfabrication and use of a corresponding integrated circuit. This disclosure also relates to bonding of dies and/or wafers for generating 3D integrated circuits.

Techniques herein provide an EDA artificial intelligence (AI) solution for optimum power performance area and cost (PPAC) for a combined N = 2 die system circuit. Embodiments can be extended to N die AI EDA routing (where N is an integer of 2 or more) for optimized circuit system design.

Techniques herein include eliminating the power and ground on either Die 1 or Die 2, or both Die 1 and Die 2, with design and fabrication defining a new common power and ground plane, which can be AI EDA optimized for both the combined Die 1/Die 2 circuit design for best PPAC. This can include a common interface and can eliminate some routing and via layers.

Techniques herein can eliminate the ground and power plane(s) for one die or both dies to be bonded together. Thus only a single ground or power plane inserted routing layer may be needed for the combined system, thus reducing signal delay, optimizing RC and reducing the number of layers. Bonded die systems benefit from AI optimized signal path routing to enable effective combined die performance. Accordingly, techniques herein improve performance and cost of stacked chips. Elimination of buried power rails (power rails buried under active devices) can be achieved with these techniques. The number of metal routing layers can be reduced using AI routing optimization that greatly reduces power consumption.

Accordingly, techniques herein provide AI optimized signal path routing to achieve power reduction, performance enhancement and cost reduction for a combined die-to-die integrated system with a common interface power and ground routing layer for both dies. Additional metal routing layers and via layers may thus be removed using the AI algorithm for the combined two-die system herein.

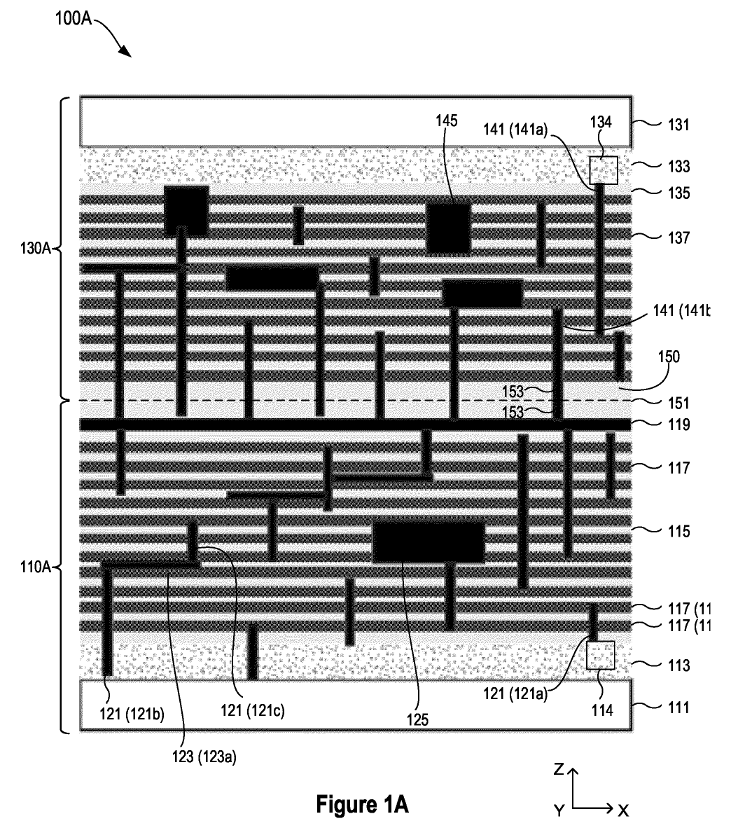

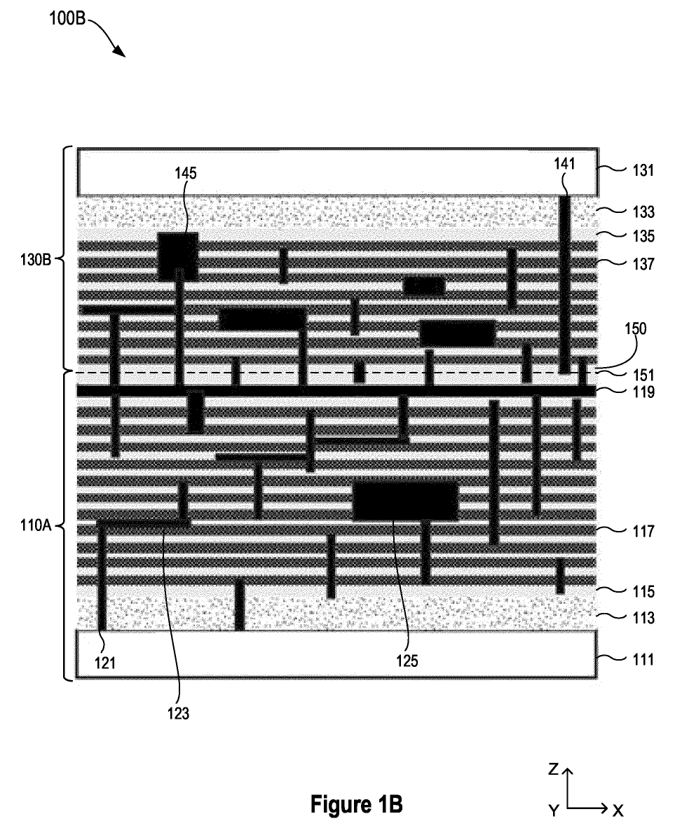

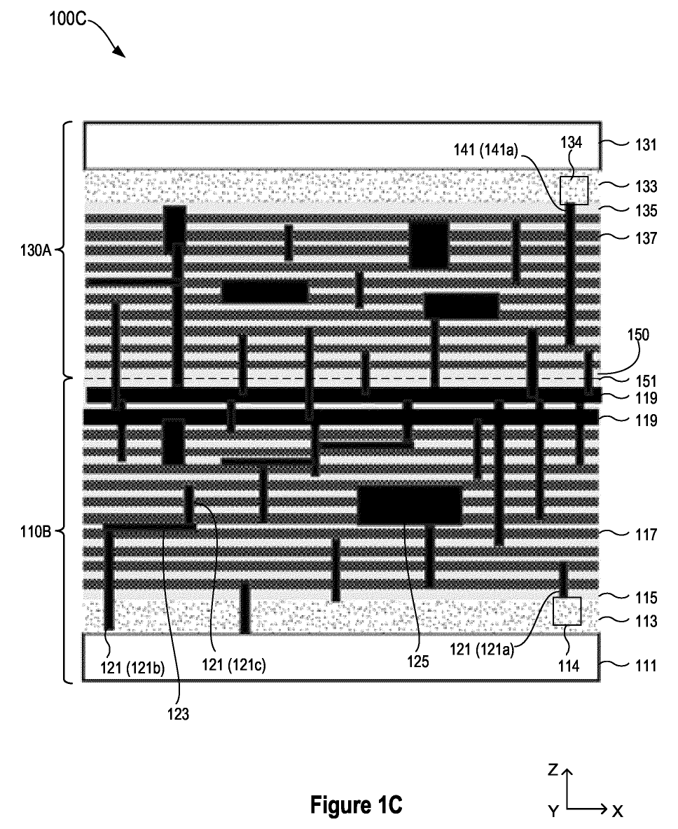

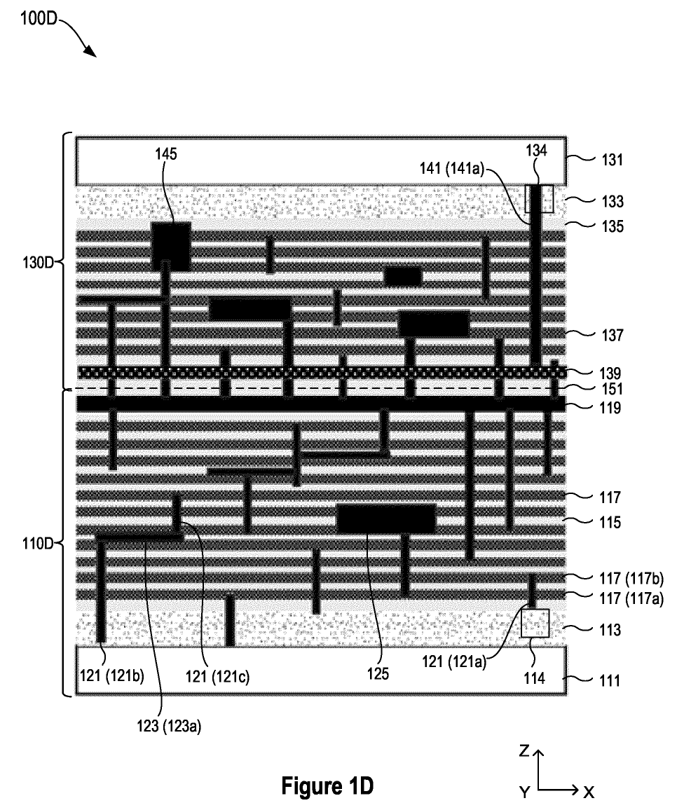

FIG. 1A shows a vertical cross-sectional view of a semiconductor device (hereinafter referred to as a device 100A) in accordance with some embodiments of the present disclosure. The device 100A includes a first die 110A and a second die 130A aligned with and bonded to each other. The first die 110A includes a first substrate 111 and first integrated circuitry for example including a first device region 113 having a first transistor 114 formed therein. The first die 110A also includes first conductive wiring layers such as first metal routing layers 117 and a power and ground plane 119. The first metal routing layers 117 are separated from each other by dielectric layers 115. While not explicitly shown, it should be understood that FIG. 1A shows a vertical cross-sectional view of the device 100A. As such, the power and ground plane 119 can be a patterned layer in the XY plane including for example a power line and a ground line separately by one or more dielectric materials, instead of being a solid pattern-less metal plane. Similarly, the first metal routing layers 117 can each independently have a respective pattern in the XY plane.

The first integrated circuitry can also include first vertical conductive structures 121 (e.g. 121a, 121b and 121c) for example in the form of through-silicon vias. While the first vertical conductive structures 121 are each shown to be in direct contact with a respective plurality of the first metal routing layers 117, it should be understood that each one of the first vertical conductive structures 121 is not necessarily electrically connected to every one of the first metal routing layers 117 that are shown to be in direct contact. Dielectric insulation structures are omitted herein for simplicity purposes. For example, a first vertical conductive structure 121a can electrically connect the first transistor 114 to one or both of first metal routing layers 117a and 117b. In one embodiment, the first vertical conductive structure 121a electrically connects the first transistor 114 to both of the first metal routing layers 117a and 117b as shown. In another embodiment, the first vertical conductive structure 121a electrically connects the first transistor 114 to the first metal routing layer 117a, not the first metal routing layer 117b. For instance, a dielectric material (not shown for simplicity purposes) can wrap around the first vertical conductive structure 121a to insulate the first vertical conductive structure 121a from the first metal routing layer 117b. In yet another embodiment, the first vertical conductive structure 121a electrically connects the first transistor 114 to the first metal routing layer 117b, not the first metal routing layer 117a. For instance, a dielectric material (not shown for simplicity purposes) can wrap around the first vertical conductive structure 121a to insulate the first vertical conductive structure 121a from the first metal routing layer 117a.

Similarly, first vertical conductive structures 121b and 121c are respectively shown to be in direct contact with four and three of the first metal routing layers 117, which however does not necessarily mean that the first vertical conductive structures 121b and 121c are respectively electrically connected to all four and all three of the first metal routing layers 117. As explained above, wrapped-around dielectric insulation (not shown for simplicity purposes) may exist to insulate the first vertical conductive structures 121b and 121c from one or more of the first metal routing layers 117. This design can offer flexible signal routing and adapt to diverse requirements.

The first integrated circuitry can further include first between-layer routing structures 123 (e.g. 123a) and first interlayer routing structures 125. For instance, a first between-layer routing structure 123a can electrically the first vertical conductive structures 121b and 121c. While the first between-layer routing structure 123a is shown to be in direct contact with two neighboring ones of the first metal routing layers 117, it should be understood that the first between-layer routing structure 123a can be electrically insulated from the two neighboring ones of the first metal routing layers 117 by dielectric insulation (not shown for simplicity purposes) above and below the first between-layer routing structure 123a. The first interlayer routing structures 125 may electrically connect a plurality of the first metal routing layers 117.

Additionally, FIG. 1A shows merely one vertical cross-sectional view of the device 100A, it should be understood that in other vertical cross-sectional views (not shown for simplicity purposes) of the device 100A, the first die 110A may include first transistors in the first device region 113 that are electrically connected to the power line and/or the ground line of the power and ground plane 119 via the first vertical conductive structures 121, the first between-layer routing structures 123, the first interlayer routing structures 125 or any combinations thereof.

The second die 130A includes a second substrate 131 and second integrated circuitry for example including a second device region 133 having a second transistor 134 formed therein. The second die 130A also includes second conductive wiring layers such as second metal routing layers 137. The second metal routing layers 137 are separated from each other by dielectric layers 135. Since FIG. 1A shows a vertical cross-sectional view of the device 100A, the second metal routing layers 137 can each independently have a respective pattern in the XY plane.

The second integrated circuitry can also include second vertical conductive structures 141 (e.g. 141a and 141b) for example in the form of through-silicon vias. While the second vertical conductive structures 141 are each shown to be in direct contact with a respective plurality of the second metal routing layers 137, it should be understood that each one of the second vertical conductive structures 141 is not necessarily electrically connected to every one of the second metal routing layers 137 that are shown to be in direct contact. That is, the second vertical conductive structures 141 are similar to the first vertical conductive structures 121. Similar descriptions have been provided above and will thus be omitted herein for simplicity purposes.

The second integrated circuitry can further include second between-layer routing structures (not shown for simplicity purposes) and second interlayer routing structures 145, which are similar to the first between-layer routing structures 123 and the first interlayer routing structures 125 respectively. Similar descriptions have been provided above and will thus be omitted herein for simplicity purposes.

The device 100A can include a bonding layer 150 via which the first die 110A and the second die 130A are bonded to each other. The bonding layer 150 includes a bonding interface 151 where (conductive) bonding structures 153 of the first die 110A and the second die 130A are aligned with each other and electrically connected to each other to form continuous conductive path across the bonding interface 151. As a result, the first metal routing layers 117 can be electrically connected with the second metal routing layers 137. Moreover, the power and ground plane 119 of the first die 110A can be electrically connected to the second integrated circuitry of the second die 130A. For instance, one or more of the second metal routing layers 137 can be electrically connected to the power and ground plane 119 via the bonding structures 153 and second vertical conductive structures (e.g. 141b).

Additionally, FIG. 1A shows merely one vertical cross-sectional view of the device 100A, it should be understood that in other vertical cross-sectional views (not shown for simplicity purposes) of the device 100A, the second die 130A may include second transistors in the second device region 133 that are electrically connected to the power line and/or the ground line of the power and ground plane 119 of the first die 110A via the second vertical conductive structures 141, the second between-layer routing structures, the second interlayer routing structures 145, the bonding structures 153 or any combinations thereof.

In some embodiments, the second die 130A may include no power and ground plane, no power line and no ground line. However, the second die 130A uses the power line and the ground line of the power and ground plane 119 of the first die 110A, as explained above.

Since the power and ground plane 119 is adjacent to the bonding interface 151 and can be electrically connected to both the first integrated circuitry of the first die 110A and the second integrated circuitry of the second die 130A, buried power rails may not be needed for the first die 110A, the second die 130A or both. As used herein, a “buried power rail” (BPR) generally refers to a conductive structure formed within a substrate and/or below one or more device layers, configured to distribute power, such as a supply voltage or ground potential, to active devices fabricated in an integrated circuit. A BPR is positioned beneath the device region, typically separated from the active device layer by an insulating dielectric material, and is electrically connected to transistors or other circuit elements through vertical conductive structures, such as vias or contacts. A BPR can enable efficient routing of power or ground signals with reduced parasitic resistance and capacitance, therefore improving device performance and area utilization.

In some embodiments, one or more first PBRs may be formed “below” the first device region 113 for example within the first substrate 111 or between the first device region 113 and the first substrate 111. Note that “buried” and “below” when describing a BPR refers to an orientation where a substrate is considered a bottommost structure of a device or where a substrate is considered to be positioned below an device region. For instance the second die 130A here is flipped 180 degrees or positioned upside down, relative to the first die 110A. While it can be said that one or more second PBRs may be formed “below” the second device region 133 for example between the second device region 133 and the second substrate 131 or within the second substrate 131, the one or more second PBRs “below” the second device region 133 refers to an orientation of the second die 130A before being flipped or an orientation where the second substrate 131 is a bottommost structure of the second die 130A.

In some embodiments, the first die 110A includes no BPR, and the second die 130A includes no BPR. For example, the first die 110A includes no BPR, between which and the bonding interface 151, the first integrated circuitry (including the first device region 113 and the first metal routing layers 117) is positioned. The second die 130A includes no BPR, between which and the bonding interface 151, the second integrated circuitry (including the second device region 133 and the second metal routing layers 137) is positioned.

While referred to as the first die 110A and the second die 130A, it should be understood that the first die 110A and the second die 130A can each independently be an individual die or a die as a part of or entirety of a wafer. For instance, the device 100A may include a plurality of the first die 110A and a plurality of the second die 130A bonded at the bonding interface 151.

While not explicitly shown, it should be understood that FIG. 1A shows a vertical cross-sectional view of the device 100A. As such, the first metal routing layers 117 and the second metal routing layers 137 may each independently have various patterns in the XY plane, despite being shown herein as full-length solid lines merely for illustrative purposes.

In one embodiment, the bonding layer 150 includes one or more bonding defects (not shown) at the bonding interface 151. Such bonding defects at the bonding interface 151 can include, but are not limited to, a void (e.g. a pin hole), a gap (e.g. unbonded metal pads or dielectrics), a crack (e.g. delamination), a trapped particle (e.g. foreign material), etc. The void, gap or crack can be vacuum or include trapped air. Such bonding defects can be characteristic of the device 100A. In other words, the bonding interface 151 can be different from an interface between two layers where one layer is deposited or formed over the other layer. Such bonding defects can be characterized or detected by known techniques such as acoustic micro-imaging, infrared transmission spectrometry, the double cantilever beam test, the (micro) Chevron test, bonding strength measurement, white light interferometry, etc. In another embodiment, there is no bonding defect at the bonding interface 151. However, the bonding interface 151 may still exist when two or more different materials are bonded together. In yet another embodiment, the first die 110A is bonded seamlessly to the second die 130A. That is, the bonding interface 151 may not physically exist but is an imaginary interface when there is no bonding defect at the bonding interface 151. Accordingly, the bonding layer 150 can be a unitary piece, instead of two layers with a real interface therebetween.

“Substrate” or “wafer” as used herein generically refers to an object being processed in accordance with the invention. The substrate may include any material portion or structure of a device, particularly a semiconductor or other electronics device, and may, for example, be a base substrate structure, such as a semiconductor wafer, reticle, or a layer on or overlying a base substrate structure such as a thin film. Thus, substrate is not limited to any particular base structure, underlying layer or overlying layer, patterned or un-patterned, but rather, is contemplated to include any such layer or base structure, and any combination of layers and/or base structures. The description may reference particular types of substrates, but this is for illustrative purposes only.

The substrate can be any suitable substrate, such as a silicon (Si) substrate, a germanium (Ge) substrate, a silicon-germanium (SiGe) substrate, and/or a silicon-on-insulator (SOI) substrate. The substrate may include a semiconductor material such as a Group IV semiconductor, a Group III-V compound semiconductor, or a Group II-VI oxide semiconductor. The Group IV semiconductor may include Si, Ge, or SiGe. The substrate may be a bulk wafer or an epitaxial layer.

FIG. 1B shows a vertical cross-sectional view of a semiconductor device (hereinafter referred to as a device 100B) in accordance with some embodiments of the present disclosure. The embodiment of the device 100B is similar to the embodiment of the device 100A. Note that similar or identical components are labeled with similar or identical numerals in the present disclosure unless specified otherwise. Descriptions have been provided above and will be omitted for simplicity purposes.

As shown, the device 100B includes the first die 110A and a second die 130B. The second die 130B is similar to the second die 130A, however with fewer metal routing layers due to electronic design automation (EDA) artificial intelligence (AI) optimization which will be further explained later. In the example of FIG. 1A, the second die 130A includes eleven of the second metal routing layers 137. In the example of FIG. 1B, the second die 130B includes eight of the second metal routing layers 137. Eleven minus eight equals three. That is to say, three routing layers (e.g. a ground layer, a positive power layer and a negative power layer) can be eliminated by EDA AI optimization. For simplicity purposes, the first transistors of the first die 110A and second transistors of the second die 130B are not shown in FIG. 1B. Similar descriptions have been provided for FIG. 1A and will thus be omitted herein for simplicity purposes.

FIG. 1C shows a vertical cross-sectional view of a semiconductor device (hereinafter referred to as a device 100C) in accordance with yet some embodiments of the present disclosure. The embodiment of the device 100C is similar to the embodiment of the device 100A. Note that similar or identical components are labeled with similar or identical numerals in the present disclosure unless specified otherwise. Descriptions have been provided above and will be omitted for simplicity purposes.

As shown, the device 100C includes a first die 110B and the second die 130A. The first die 110B is similar to the first die 110A, however with two power and ground planes 119, which can be used for parallel circuits and provide better connections than a single power and ground plane.

FIG. 1D shows a vertical cross-sectional view of a semiconductor device (hereinafter referred to as a device 100D) in accordance with yet another embodiment of the present disclosure. The embodiment of the device 100D is similar to the embodiment of the device 100B. Note that similar or identical components are labeled with similar or identical numerals in the present disclosure unless specified otherwise. Descriptions have been provided above and will be omitted for simplicity purposes.

As shown, the device 100D includes a first die 110D and a second die 130D. The first die 110D is similar to the first die 110A. The second die 130D is similar to the second die 130B. However the second die 130D includes a power and ground plane 139.

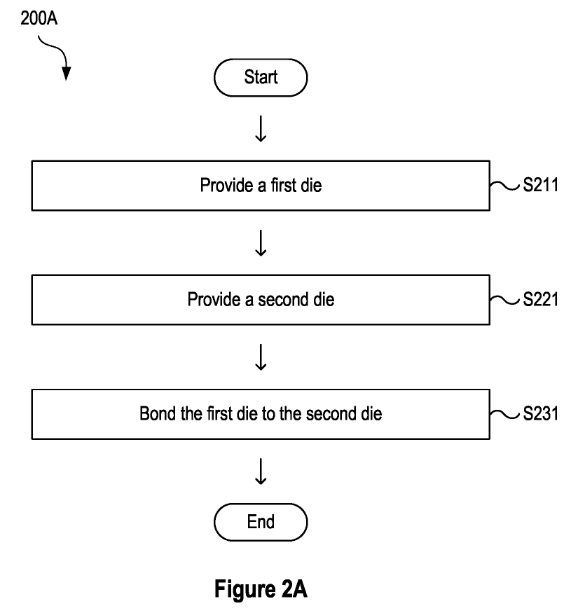

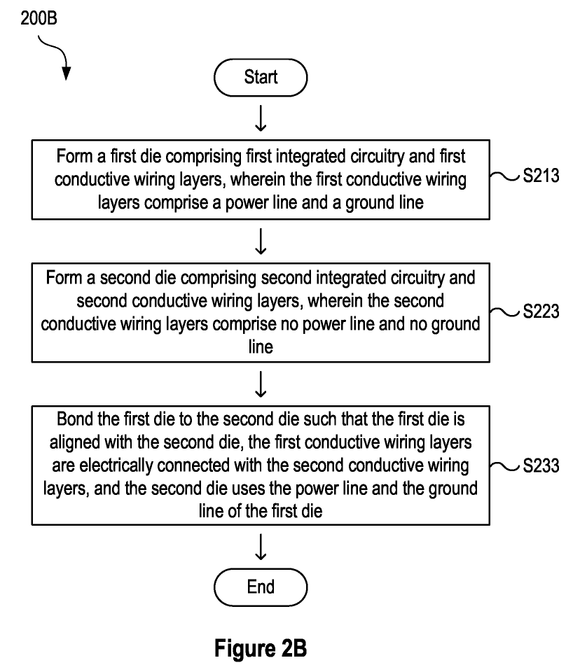

FIG. 2A shows a flow chart of a process 200A for manufacturing a semiconductor device such as the device 100A, the device 100B, the device 100C, the device 100D and the like, in accordance with some embodiments of the present disclosure. At step S211, a first die is provided by oneself or someone else. At step S221, a second die is provided by oneself or someone else. At step S231, the first die is bonded to the second die.

FIG. 2B shows a flow chart of a process 200B for manufacturing a semiconductor device such as the device 100A, the device 100B, the device 100C, the device 100D and the like, in accordance with some embodiments of the present disclosure.

At step S213, a first die including first integrated circuitry and first conductive wiring layers is formed. The first conductive wiring layers include a power line and a ground line. At step S223, a second die including second integrated circuitry and second conductive wiring layers is formed. The second conductive wiring layers include no power line and no ground line. At step S233, the first die is bonded to the second die such that the first die is aligned with the second die. The first conductive wiring layers are electrically connected with the second conductive wiring layers, and the second die uses the power line and the ground line of the first die.

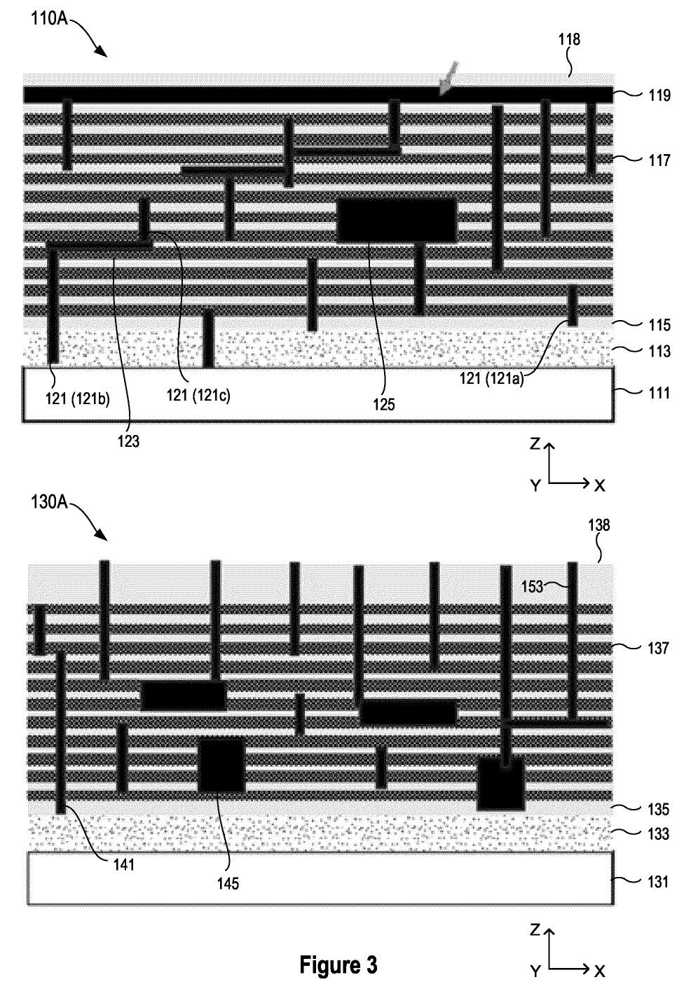

As can be appreciated, there are several process flows contemplated herein. An example flow of FIG. 3 involves elimination of the metal power and metal grounding routing plane (that is, power and ground contained in the same plane) in one die for bonding in a two-or-more combined die system using an effective AI routing for both individual circuit builds. The following examples are non-limiting and use specific numbers to better explain examples.

FIG. 3 can show vertical cross-sectional views of the first die 110A and the second die 130A prior to bonding. For instance, metal layers (e.g. the first metal routing layers 117 and the power and ground plane 119) are formed on Die 1 (e.g. the first die 110A), and metal layers (e.g. the second metal routing layers 137) are formed in Die 2 (e.g. the second die 130A). In a non-limiting example, twelve metal layers are formed in Die 1, including eleven metal routing layers (e.g. 117) and one power and ground plane (e.g. 119), and eleven metal layers are formed in Die 2, including eleven metal routing layers (e.g. 137) and no power and grounding layer.

It should be understood that Die 1 and Die 2 can each independently have any number of metal layers and may have different numbers between the two dies to be bonded. In addition, EDA AI design can place the metal power and ground routing layer(s) and all metal layers such that both Die 1 and Die 2 are optimized for PPAC, thus enabling the maximum combined performance of Die 1 and Die 2. Moreover, while only one power and ground plane (e.g. 119) is shown, Die 1 and Die 2 overall may have a plurality of power and ground planes. Not all power and ground layers are visible from this cross section. Techniques herein enable any location or combinations of power and ground layers on either die.

Then, Die 2 (e.g. 130A) can be flipped and bonded to Die 1 (e.g. 110A) after the via connections and metal routing signals have been optimized to best utilize PPAC between the two-die combined system. As a result, the bonding layer 150 is formed, and the device 100A is formed as shown in FIG. 1A.

In this example, a first pre-bonding layer 118 of the first die 110A and a second pre-bonding layer 138 of the second die 130A include a same dielectric bonding material, such as silicon oxide, and thus can be bonded by fusion bonding. In another example (not shown), the first die 110A and the second die 130A can be bonded by another wafer bonding technique, such as surface-activated bonding, plasma-activated bonding, anodic bonding, eutectic bonding, glass frit bonding, adhesive bonding, thermocompression bonding, reactive bonding, transient liquid phase diffusion bonding or the like. Accordingly, the first pre-bonding layer 118 and the second pre-bonding layer 138 may include one or more different dielectric bonding materials from each other.

As shown, the second pre-bonding layer 138 includes the bonding structures 153. While not explicitly shown, it should be understood that the first pre-bonding layer 118 in FIG. 3 can also include the bonding structures 153 (for example as shown in FIG. 1), which are aligned with the bonding structures 153 of the second pre-bonding layer 138, prior to bonding, in order to form continuous conductive path through the bonding layer 150 after bonding. Since FIG. 3 shows merely one vertical cross-sectional view of the first die 110A, the bonding structures 153 may exist in other vertical cross-sectional views (not shown for simplicity purposes) of the first die 110A, additionally or alternatively.

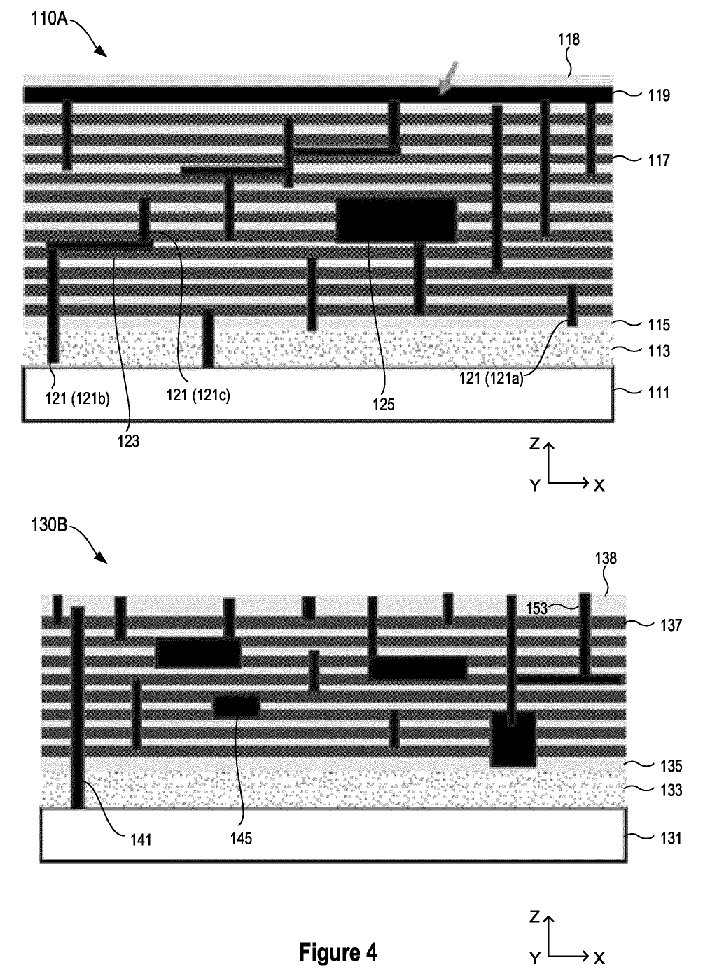

FIG. 4 shows vertical cross-sectional views of the first die 110A and the second die 130B prior to bonding, in accordance with some embodiments of the present disclosure. For instance, metal layers (e.g. the first metal routing layers 117 and the power and ground plane 119) are formed on Die 1 (e.g. the first die 110A), and metal layers (e.g. the second metal routing layers 137) are formed in Die 2 (e.g. the second die 130B). In a non-limiting example, twelve metal layers are formed in Die 1, including eleven metal routing layers (e.g. 117) and one power and ground plane (e.g. 119), and eight metal layers are formed in Die 2, including eight metal routing layers (e.g. 137) and no power and grounding layer.

It should be understood that Die 1 and Die 2 can each independently have any number of metal layers and may have different numbers between the two dies to be bonded. In addition, EDA AI design can place the metal power and ground routing layer(s) and all metal layers such that both Die 1 and Die 2 are optimized for PPAC, thus enabling the maximum combined performance of Die 1 and Die 2. Moreover, while only one power and ground plane (e.g. 119) is shown, Die 1 and Die 2 overall may have a plurality of power and ground planes. Not all power and ground layers are visible from this cross section. Techniques herein enable any location or combinations of power and ground layers on either die. Furthermore, compared with the second die 130A in FIG. 3, three routing layers (e.g. a ground layer, a positive power layer and a negative power layer) have been eliminated in Die 2 (e.g. the second die 130B) in FIG. 4 due to EDA AI optimized routing solution.

Then, Die 2 (e.g. 130B) can be flipped and bonded to Die 1 (e.g. 110A) after the via connections and metal routing signals have been optimized to best utilize PPAC between the two-die combined system. The first pre-bonding layer 118 and the second pre-bonding layer 138 can be bonded by various methods as previously discussed. As a result, the bonding layer 150 is formed, and the device 100B is formed as shown in FIG. 1B. Note that this technique provides reduction of multiple metal layers with EDA AI optimized routing layers in addition to the power and ground plane.

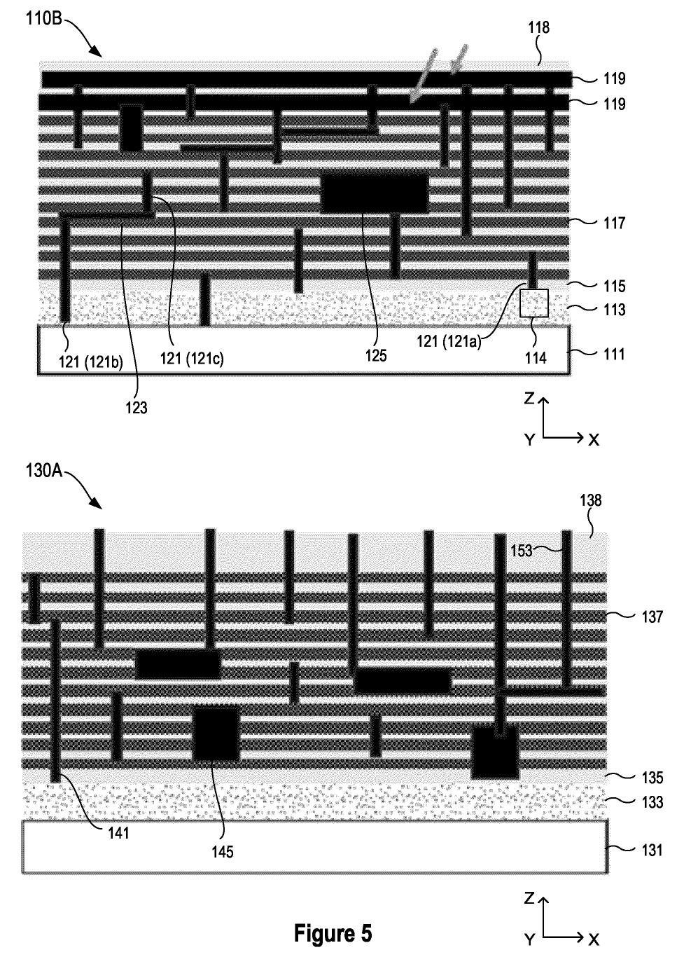

FIG. 5 shows vertical cross-sectional views of the first die 110B and the second die 130A prior to bonding, in accordance with some embodiments of the present disclosure. For instance, metal layers (e.g. the first metal routing layers 117 and the power and ground planes 119) are formed on Die 1 (e.g. the first die 110A), and metal layers (e.g. the second metal routing layers 137) are formed in Die 2 (e.g. the second die 130A). In a non-limiting example, twelve metal layers are formed in Die 1, including ten metal routing layers (e.g. 117) and two power and ground planes (e.g. 119), and eleven metal layers are formed in Die 2, including eleven metal routing layers (e.g. 137) and no power and grounding layer.

It should be understood that Die 1 and Die 2 can each independently have any number of metal layers and may have different numbers between the two dies to be bonded. In addition, EDA AI design can place the metal power and ground routing layer(s) and all metal layers such that both Die 1 and Die 2 are optimized for PPAC, thus enabling the maximum combined performance of Die 1 and Die 2. Moreover, while exactly two power and ground planes (e.g. 119) are shown, Die 1 and Die 2 overall may have a plurality of power and ground planes. Not all power and ground layers are visible from this cross section. Techniques herein enable any location or combinations of power and ground layers on either die. Furthermore, a role of Die 1 or Die 2 can be reversed in that only one die needs the two planes (e.g. 119) to cover grounding and power routing. In cross sections where power and ground lines cross in vertical hookup, there may be an insulator to separate out the two connections.

Then, Die 2 (e.g. 130A) can be flipped and bonded to Die 1 (e.g. 110B) after the via connections and metal routing signals have been optimized to best utilize PPAC between the two-die combined system. The first pre-bonding layer 118 and the second pre-bonding layer 138 can be bonded by various methods as previously discussed. As a result, the bonding layer 150 is formed, and the device 100C is formed as shown in FIG. 1C. Note that techniques provide reduction of multiple metal layers with EDA AI optimized routing layers in addition to the power and ground plane. In cross sections where power and ground lines cross in vertical hookup, there may be insulator to separate out the two connections.

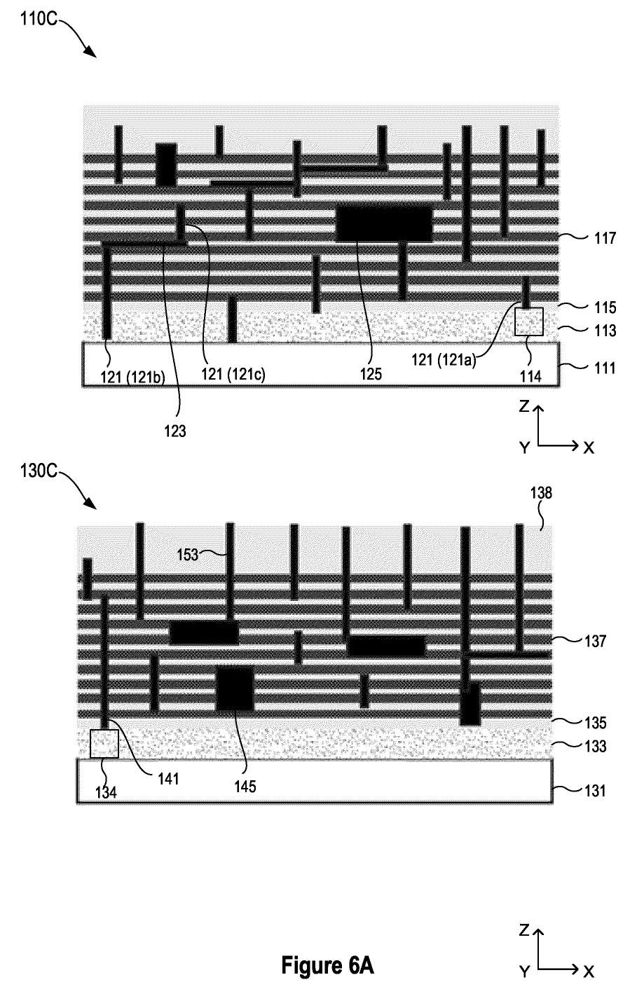

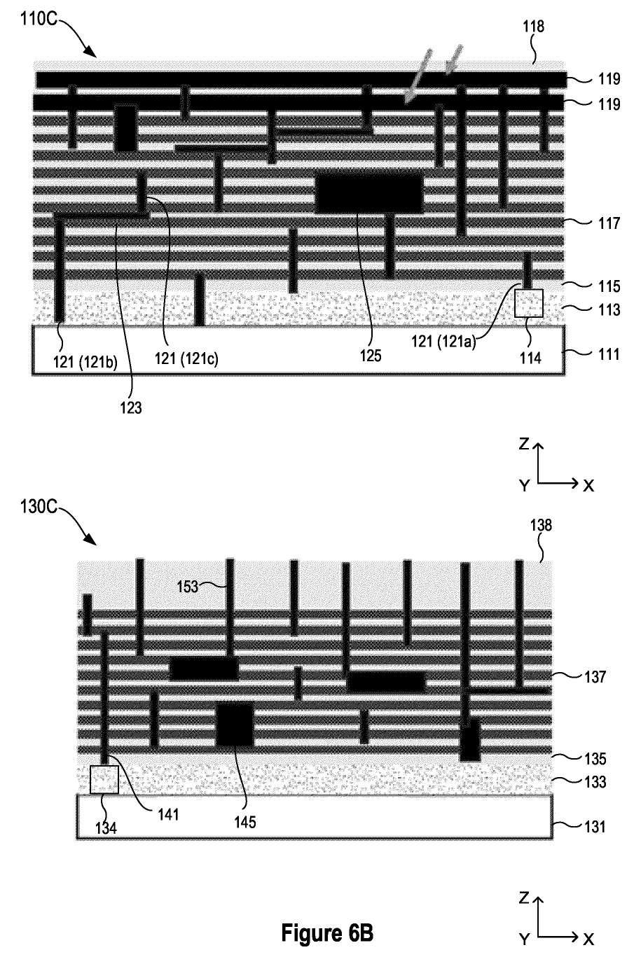

FIGS. 6A and 6B show vertical cross-sectional views of a first die 110C and a second die 130C at various intermediate steps of manufacturing, in accordance with some embodiments of the present disclosure. A process flow of FIGS. 6A and 6B can enable elimination of the metal power and metal grounding routing layers for both Die 1 (e.g. the first die 110C) and Die 2 (the second die 130C) and utilize a common interface power and ground routing layer for one or more dies to be bonded in combined Die system for optimum PPAC.

In FIG. 6A, metal layers (e.g. the first metal routing layers 117) are formed on Die 1 (e.g. the first die 110C), and metal layers (e.g. the second metal routing layers 137) are also formed in Die 2 (e.g. the second die 130C). In a non-limiting example, ten metal layers are formed in Die 1, including ten metal routing layers (e.g. 117) and no power and ground plane, and ten metal layers are formed in Die 2, including ten metal routing layers (e.g. 137) and no power and grounding layer.

It should be understood that Die 1 and Die 2 can each independently have any number of metal layers and may have different numbers between the two dies to be bonded. In addition, EDA AI design can place the metal power and ground routing layer(s) and all metal layers such that both Die 1 and Die 2 are optimized for PPAC, thus enabling the maximum combined performance of Die 1 and Die 2 obtained with a common interface power and ground routing layer.

In FIG. 6B, AI EDA simulation is used to determine the optimum routing layout for both Die 1 and Die 2. A power and ground interface (including power and ground) according to the AI optimized routing is formed on Die 1 as one invention option. For instance, the power and ground planes 119 are formed on the first die 110C based on the AI optimized routing.

While exactly two power and ground planes (e.g. 119) are shown, Die 1 and Die 2 overall may have a plurality of power and ground planes. Not all power and ground layers are visible from this cross section. Techniques herein enable any location or combinations of power and ground layers on either die. Furthermore, a role of Die 1 or Die 2 can be reversed in that only one die needs the two planes (e.g. 119) to cover grounding and power routing. In cross sections where power and ground lines cross in vertical hookup, there may be an insulator to separate out the two connections.

Then, Die 2 (e.g. 130C) can be flipped and bonded to Die 1 (e.g. 110C) after the via connections and metal routing signals have been optimized to best utilize PPAC between the two-die combined system. The first pre-bonding layer 118 and the second pre-bonding layer 138 can be bonded by various methods as previously discussed. As a result, the bonding layer 150 is formed. The structure of the first die 110C bonded to the second die 130C is similar to the embodiment of the device 100C in FIG. 1C and thus is not shown here for simplicity purposes. Note that techniques provide reduction of multiple metal layers with EDA AI optimized routing layers in addition to the power and ground plane. In cross sections where power and ground lines cross in vertical hookup, there is may be insulator to separate out the two connections.

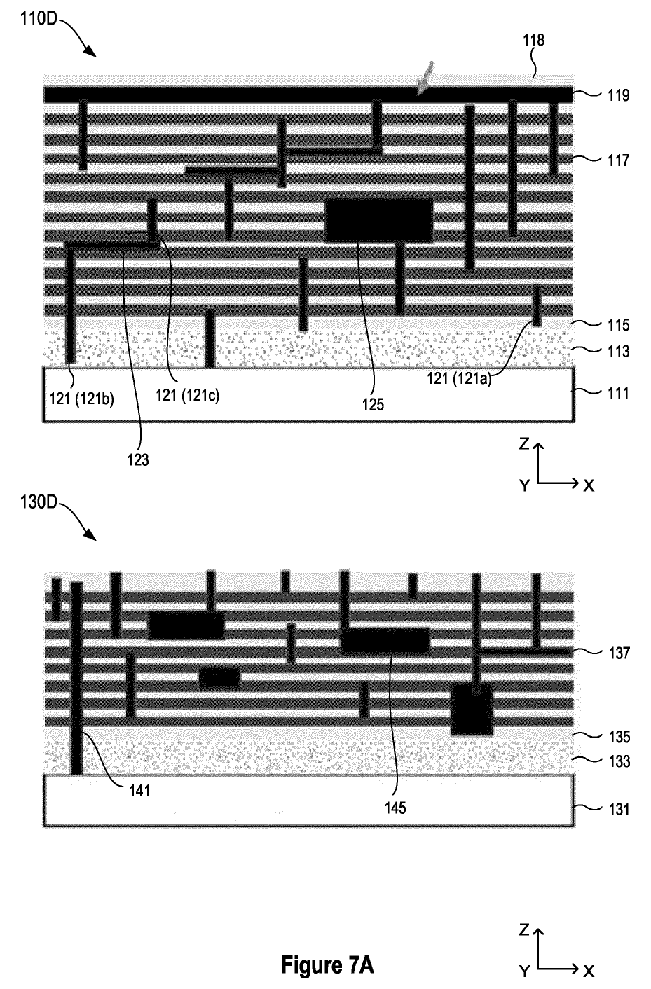

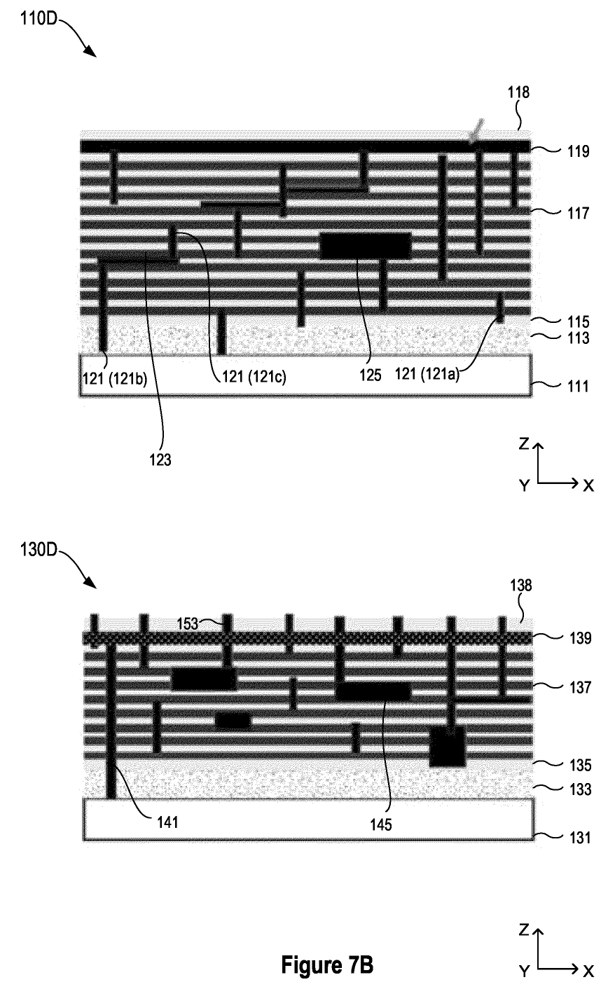

FIGS. 7A and 7B show vertical cross-sectional views of a first die 110D and a second die 130D at various intermediate steps of manufacturing, in accordance with some embodiments of the present disclosure. A process flow of FIGS. 7A and 7B can enable elimination of the metal power and metal grounding routing layers for Die 2 only and utilize common interface power and existing non-AI optimized ground routing layer for one or more dies to be bonded in a combined die system for optimum PPAC. This enables one die to keep the existing power and ground plane (e.g. Die 1) but enables the insert of AI design optimized routing to hook up to another die (e.g. Die 2).

In FIG. 7A, metal layers (e.g. the first metal routing layers 117 and the power and ground plane 119) already exist on Die 1 (e.g. the first die 110D), and metal layers (e.g. the second metal routing layers 137) are formed in Die 2 (e.g. the second die 130C). In a non-limiting example, twelve metal layers exist in Die 1, including eleven metal routing layers (e.g. 117) and one power and ground plane (e.g. 119), and eight metal layers are formed in Die 2, including eight metal routing layers (e.g. 137) and no power and grounding layer.

It should be understood that Die 1 and Die 2 can each independently have any number of metal layers and may have different numbers between the two dies to be bonded. In addition, EDA AI design can place the metal power and ground routing layer(s) and all metal layers such that both Die 1 and Die 2 are optimized for PPAC, thus enabling the maximum combined performance of Die 1 and Die 2 obtained with a common interface power and ground routing layer. Three routing layers (e.g. a ground layer, a positive power layer and a negative power layer) have been eliminated in Die 2 (e.g. the second die 130D) due to EDA AI optimized routing solution.

In FIG. 7B, AI EDA simulation is used to determine the optimum routing layout for both Die 1 and Die 2. A power and ground interface (including power and ground) according to the AI optimized routing is formed on Die 2 as one invention option. For instance, the power and ground plane 139 are formed on the second die 130D based on the AI optimized routing.

While exactly two power and ground planes (e.g. 119 and 139) are shown, Die 1 and Die 2 may each have a plurality of power and ground planes. Not all power and ground layers are visible from this cross section. Techniques herein enable any location or combinations of power and ground layers on either die. In cross sections where power and ground lines cross in vertical hookup, there may be an insulator to separate out the two connections.

Then, Die 2 (e.g. 130D) can be flipped and bonded to Die 1 (e.g. 110D) after the via connections and metal routing signals have been optimized to best utilize PPAC between the two-die combined system. The first pre-bonding layer 118 and the second pre-bonding layer 138 can be bonded by various methods as previously discussed. As a result, the bonding layer 150 is formed, and the device 100D is formed as shown in FIG. 1D. Note that techniques provide reduction of multiple metal layers with EDA AI optimized routing layers in addition to the power and ground plane. In cross sections where power and ground lines cross in vertical hookup, there is may be insulator to separate out the two connections.

This example is advantageous to address a given Die 1 which might be a complex microprocess that would have multiple different combined circuit designs for Die 2. Thus greatly enhanced PPAC is achieved with just modification of the original rail system from Die 1 integrated with Die 2 AI routing layer. In other words, the first die 110D is an existing die having gone through processing to form the first metal routing layers 117 and the power and ground plane 119, which is not AI-optimized. Techniques herein enable the first die 110D to keep the existing power and ground plane (e.g. 119) while enabling the insert of an AI-optimized power and ground plane (e.g. 139) to the second die 130D.

In the preceding description, specific details have been set forth, such as a particular geometry of a processing system and descriptions of various components and processes used therein. It should be understood, however, that techniques herein may be practiced in other embodiments that depart from these specific details, and that such details are for purposes of explanation and not limitation. Embodiments disclosed herein have been described with reference to the accompanying drawings. Similarly, for purposes of explanation, specific numbers, materials, and configurations have been set forth in order to provide a thorough understanding. Nevertheless, embodiments may be practiced without such specific details. Components having substantially the same functional constructions are denoted by like reference characters, and thus any redundant descriptions may be omitted.

Various techniques have been described as multiple discrete operations to assist in understanding the various embodiments. The order of description should not be construed as to imply that these operations are necessarily order dependent. Indeed, these operations need not be performed in the order of presentation. Operations described may be performed in a different order than the described embodiment. Various additional operations may be performed and/or described operations may be omitted in additional embodiments.

Those skilled in the art will also understand that there can be many variations made to the operations of the techniques explained above while still achieving the same objectives of the invention. Such variations are intended to be covered by the scope of this disclosure. As such, the foregoing descriptions of embodiments of the invention are not intended to be limiting. Rather, any limitations to embodiments of the invention are presented in the following claims.

What is claimed is:

1. A device, comprising:
a first die comprising first integrated circuitry and first conductive wiring layers, wherein the first conductive wiring layers comprise a power line and a ground line; and
a second die comprising second integrated circuitry and second conductive wiring layers, wherein the second conductive wiring layers comprise no power line and no ground line,
wherein the first die is aligned with and bonded to the second die, the first conductive wiring layers are electrically connected with the second conductive wiring layers, and the second die uses the power line and the ground line of the first die.

2. The device of claim 1, wherein:
the power line and the ground line are positioned proximate a bonding interface between the first die and the second die.

3. The device of claim 2, wherein:
the first conductive wiring layers comprise first metal layers and first signal path routing, which are designed using an automated wiring design system that incorporates artificial intelligence-based decision making.

4. The device of claim 3, wherein:
the second conductive wiring layers comprise second metal layers and second signal path routing, which are designed using the automated wiring design system.

5. The device of claim 3, wherein:
the automated wiring design system places wires that result in at least one of a reduction of a power metric, an increase in a performance metric, a reduction of a cost metric, and a reduction in a cost metric, compared to a design without using the automated wiring system.

6. The device of claim 1, wherein:
the first integrated circuitry comprises first transistors, and
the first die further comprises first vertical conductive structures that electrically connect the first transistors to at least one of the first wiring layers, the power line or the ground line.

7. The device of claim 6, wherein:
the second integrated circuitry comprises second transistors, and
the second die further comprises second vertical conductive structures that electrically connect the second transistors to at least one of the second wiring layers.

8. The device of claim 7, further comprising:
conductive bonding structures extending from the first die to the second die through a bonding interface therebetween,
wherein the second transistors are electrically connected to the power line and the ground line of the first die by the second vertical conductive structures and the conductive bonding structures.

9. The device of claim 1, wherein:
the power line and the ground line are positioned in at least one power and ground plane that is adjacent to a bonding interface between the first die and the second die.

10. The device of claim 9, wherein:
the first die comprises no buried power rail (BPR), between which and the bonding interface, the first integrated circuitry is positioned, and
the second die comprises no BPR, between which and the bonding interface, the second integrated circuitry is positioned.

11. The device of claim 9, wherein:
the second integrated circuitry is electrically connected to the at least one power and ground plane of the first die via the second conductive wiring layers and the bonding interface.

12. The device of claim 9, further comprising:
conductive bonding structures extending from the first die through the bonding interface to the second die,
wherein the second integrated circuitry is electrically connected to the at least one power and ground plane of the first die via the second conductive wiring layers and the conductive bonding structures.

13. The device of claim 9, wherein:
the first die further comprises a first substrate, and
the second die further comprises a second substrate.

14. The device of claim 13, wherein:
the first die, the first integrated circuitry, the first conductive wiring layers, the bonding interface, the second conductive wiring layers, the second integrated circuitry and the second die are sequentially arranged along a direction perpendicular to the bonding interface.

15. The device of claim 9, wherein:
the first conductive wiring layers further comprise first metal layers, and
the second conductive wiring layers comprise second metal layers.

16. The device of claim 15, wherein:
the at least one power and ground plane is positioned between the first metal layers and the second metal layers.

17. A method of manufacturing a device, comprising:
forming a first die comprising first integrated circuitry and first conductive wiring layers, wherein the first conductive wiring layers comprise a power line and a ground line;
forming a second die comprising second integrated circuitry and second conductive wiring layers, wherein the second conductive wiring layers comprise no power line and no ground line; and
bonding the first die to the second die such that the first die is aligned with the second die, the first conductive wiring layers are electrically connected with the second conductive wiring layers, and the second die uses the power line and the ground line of the first die.

18. The method of claim 17, wherein:
forming the first die comprises designing a first signal path using an automated wiring design system that incorporates artificial intelligence-based decision making.

19. The method of claim 18, wherein:
forming the second die comprises designing a second signal path using the automated wiring design system.

20. The method of claim 19, wherein:
forming the second die comprises designing a second signal path using the automated wiring design system, and
the automated wiring design system places wires that result in at least one of a reduction of a power metric, an increase in a performance metric, a reduction of a cost metric, or a reduction in a cost metric, compared to a design without using the automated wiring system.
